(19) United States
(12) Patent Application Publication
(10) Pub. No.: US 2017/0244846 A1
(43) Pub. Date: Aug. 24, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Norihiko TSUYUZAKI, Kanagawa (JP)

(73) Assignee: FUJI XEROX CO., LTD., Tokyo (JP)

(21) Appl. No.: 15/226,584

(22) Filed: Aug. 2, 2016

(30) Foreign Application Priority Data
Feb. 18, 2016 (JP) 2016-028771

(51) Int. Cl. H04N 1/00

(52) U.S. Cl. CPC H04N 1/00432; H04N 1/00411; H04N 1/00413; H04N 1/00416; H04N 1/00503; H04N 1/00506; H04N 2201/0094

(57) ABSTRACT

An information processing apparatus includes a first execution unit, a second execution unit, and a display. The first execution unit performs a specific function. The second execution unit performs a common function which is commonly used from specific functions. The display displays, on an operation screen for a specific function, an operation receiving section for making a direct transition to an operation screen for performing a common function related to the specific function, not via another operation screen, and displays, on the operation screen for the common function to which a transition has been made through an operation on the operation receiving section, an operation receiving section for returning back to the operation screen for the specific function.

### CROSS-REFERENCE TO RELATED APPLICATIONS

This application is based on and claims priority under 35 USC 119 from Japanese Patent Application No. 2016-028771 filed Feb. 18, 2016.

### BACKGROUND

(i) Technical Field

The present invention relates to an information processing apparatus, an information processing method, and a non-transitory computer readable medium.

(ii) Related Art

Recently, service application programs (hereinafter abbreviated as service applications) for performing specific functions have been installed in various information processing apparatuses. In addition, these information processing apparatuses are provided with, for example, setting functions for setting various types of setting information of the apparatuses, as common functions.

### SUMMARY

According to an aspect of the invention, there is provided an information processing apparatus including a first execution unit, a second execution unit, and a display. The first execution unit performs a specific function. The second execution unit performs a common function which is commonly used from specific functions. The display displays, on an operation screen for a specific function, an operation receiving section for making a direct transition to an operation screen for performing a common function related to the specific function, not via another operation screen, and displays, on the operation screen for the common function to which a transition has been made through an operation on the operation receiving section, an operation receiving section for returning back to the operation screen for the specific function.

### BRIEF DESCRIPTION OF THE DRAWINGS

Exemplary embodiments of the present invention will be described in detail based on the following figures, wherein:

FIG. 1 is a diagram illustrating the system configuration of an image forming system according to an exemplary embodiment of the present invention;

FIG. 2 is a diagram illustrating the state in which a menu screen is displayed on an operation panel of an image forming apparatus according to the exemplary embodiment of the present invention;

FIG. 3 is a diagram for describing exemplary operations performed in the case where the exemplary embodiment is not applied, when a difference detecting process is performed through a menu screen by using a difference detecting service;

FIG. 4 is a block diagram illustrating the hardware configuration of the image forming apparatus according to the exemplary embodiment of the present invention;

FIG. 5 is a block diagram illustrating the functional configuration of the image forming apparatus according to the exemplary embodiment of the present invention;

FIG. 6 is a diagram illustrating exemplary screen display data for displaying an operation screen of a difference detecting application;

FIGS. 7A and 7B are diagrams for describing the state in which the operation screen of the difference detecting service is displayed when a “Difference detecting service” button is operated on a menu screen;

FIG. 8 is a diagram illustrating an operational procedure used when operations having the same operational context as that in FIG. 3 are performed on the image forming apparatus according to the exemplary embodiment of the present invention;

FIGS. 9A and 9B are diagrams for describing a screen display made when a “Job checking” tab is selected on the operation screen of the difference detecting service;

FIG. 10 is a flowchart for describing a process of switching between operation screens when a tab for a different service is selected;

FIG. 11 is a flowchart for describing a process performed when a screen display request is received from a different service;

FIG. 12 is a diagram illustrating an exemplary operation screen displayed when a service application which a user is going to execute is a “Scan to PC” application;

FIG. 13 is a diagram illustrating an exemplary operation screen displayed when a service application which a user is going to execute is a “Scan to EMail” application; and

FIG. 14 is a diagram for describing exemplary operation screens displayed when an operation receiving section which is capable of receiving an operation from a user is not a tab-shaped operation receiving section.

### DETAILED DESCRIPTION

Exemplary embodiments of the present invention will be described in detail with reference to the drawings.

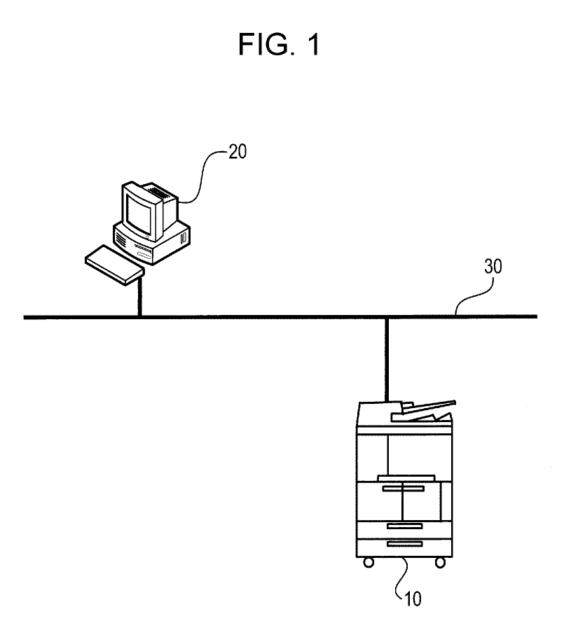

FIG. 1 is a block diagram illustrating the configuration of an image forming system according to an exemplary embodiment of the present invention.

As illustrated in FIG. 1, the image forming system according to the exemplary embodiment of the present invention includes an image forming apparatus 10 and a terminal apparatus 20 which are connected to each other over a network 30. The terminal apparatus 20 generates print data and transmits the generated print data over the network 30 to the image forming apparatus 10. The image forming apparatus 10 receives the print data transmitted from the terminal apparatus 20, and outputs an image according to the print data on a sheet. The image forming apparatus 10 is a so-called multi-function device provided with multiple functions, such as a print function, a scan function, a copy function, and a facsimile function.

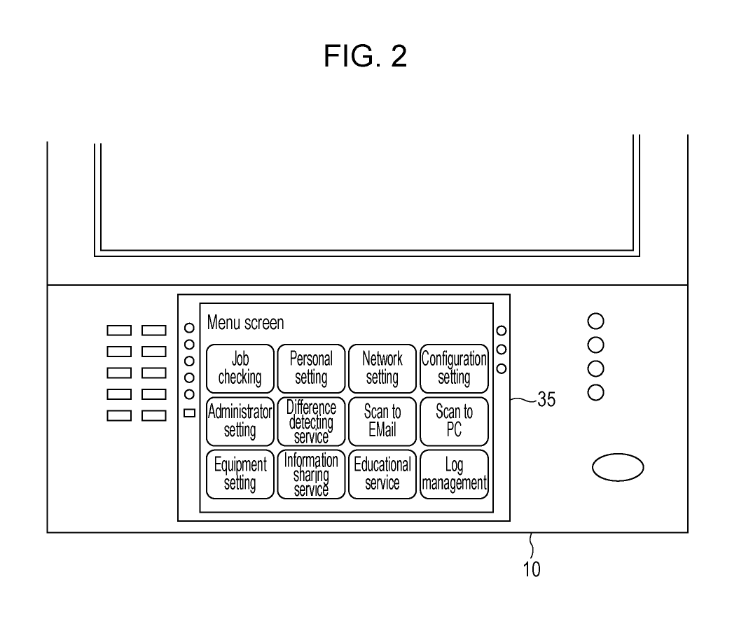

As illustrated in FIG. 2, the image forming apparatus 10 has a configuration in which a menu screen (function list screen) is displayed on an operation panel 35 including a touch panel, and in which various functions (services) may be selected.

As services available from such a menu screen, there are the following types of services: services, such as a difference detecting service, for performing only specific functions; and services, such as equipment setting and network setting performing common functions for making various settings, which are commonly used in multiple services.

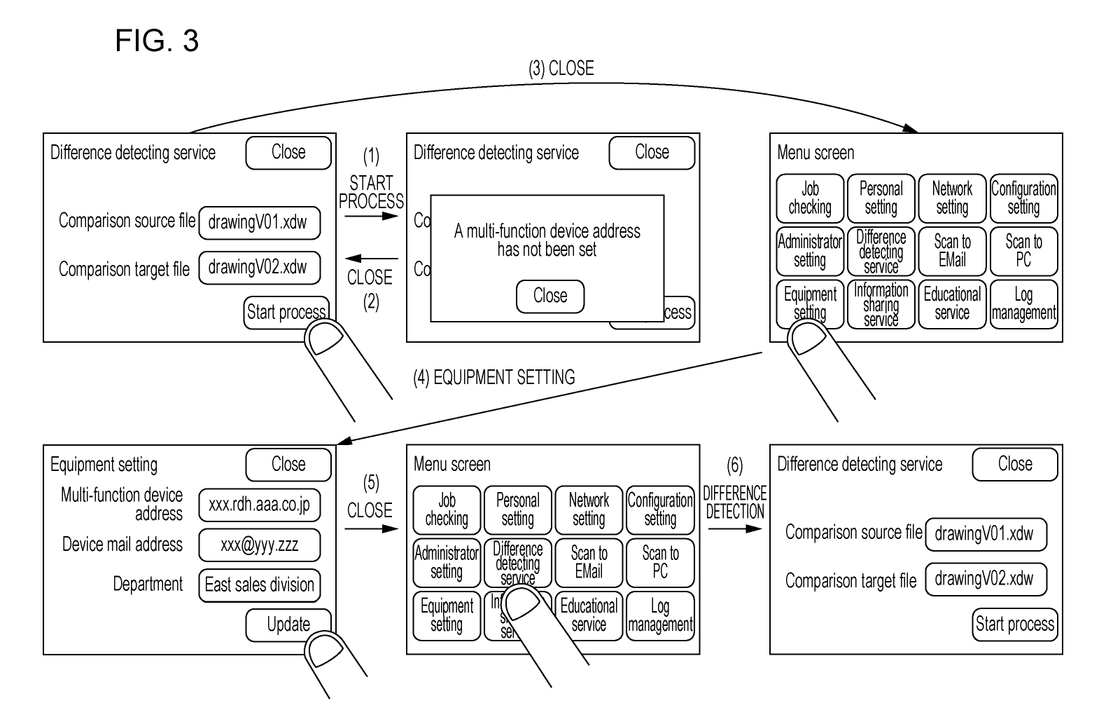

Exemplary operations to which the exemplary embodiment is not applied and in which the difference detecting service is used through such a menu screen to perform a difference detecting process will be described with reference to FIG. 3.

The difference detecting process is, for example, a process of detecting the difference between a new drawing and an old drawing, and displaying, in a color-coded manner, portions added in the new drawing, portions deleted in the new drawing, and portions for which no changes are made between the new and old drawings.

A description will be made under the assumption that, in execution of the difference detecting process, information about a multi-function device address and a device mail address has to be set in advance to specify an output destination and the like of the difference detection result.

In FIG. 3, a description will be made under the assumption that a user has selected the difference detecting service from a menu screen and has displayed an operation screen of the difference detecting service. An operational procedure used when the user has not set information about a multi-function device address and a device mail address in advance will be described below.

(1) The user specifies a comparison source file and a comparison target file on the operation screen, and operates a process start button.

(2) Since a multi-function device address and the like have not been set, a warning, “A multi-function device address has not been set”, is displayed. The user operates a “Close” button and goes back to the original operation screen of the difference detecting service.

(3) The user operates a “Close” button on the difference detecting service screen, and displays the menu screen.

(4) The user selects the equipment setting service on the menu screen, and makes a transition to an operation screen of the equipment setting service.

(5) The user inputs a multi-function device address and the like on the operation screen for equipment setting, and presses an “Update” button to register the information. The user then operates a “Close” button and goes back to the menu screen.

(6) The user selects the difference detecting service again on the menu screen, and makes a transition to the operation screen of the difference detecting service.

After the above-described operations are performed, the user operates a “Start process” button on the operation screen of the difference detecting service, whereby the difference detecting process is performed.

Thus, in the procedure illustrated in FIG. 3, a transition between the difference detecting service and the equipment setting service has to be made via the menu screen. This shows that many operations have to be performed.

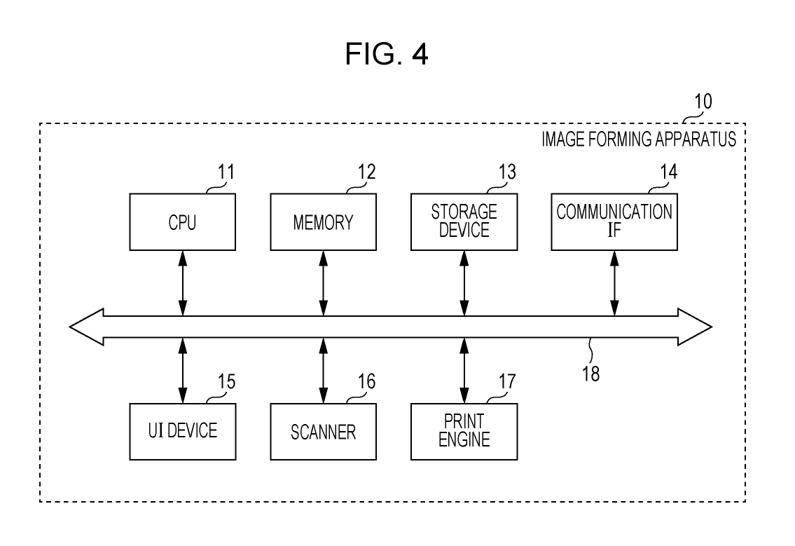

FIG. 4 illustrates the hardware configuration of the image forming apparatus 10 in the image forming system according to the exemplary embodiment.

As illustrated in FIG. 4, the image forming apparatus 10 includes a central processing unit (CPU) 11, a memory 12, a storage device 13 such as a hard disk drive (HDD), a communication interface (IF) 14 which receives/transmits data from/to an external apparatus and the like over the network 30, a user interface (UI) device 15 which includes a touch panel or a keyboard and a liquid crystal display, a scanner 16, and a print engine 17. These components are connected to one another via a control bus 18.

The print engine 17 prints an image on a recording medium such as a print sheet through processes, such as charging, exposure to light, developing, transferring, and fixing.

The CPU 11 performs a predetermined process on the basis of control programs stored in the memory 12 or the storage device 13, and controls operations of the image forming apparatus 10. In the exemplary embodiment, a description is made under the assumption that the CPU 11 reads and executes the control programs stored in the memory 12 or the storage device 13. Alternatively, the programs stored in a storage medium such as a compact disc-read-only memory (CD-ROM) may be supplied to the CPU 11.

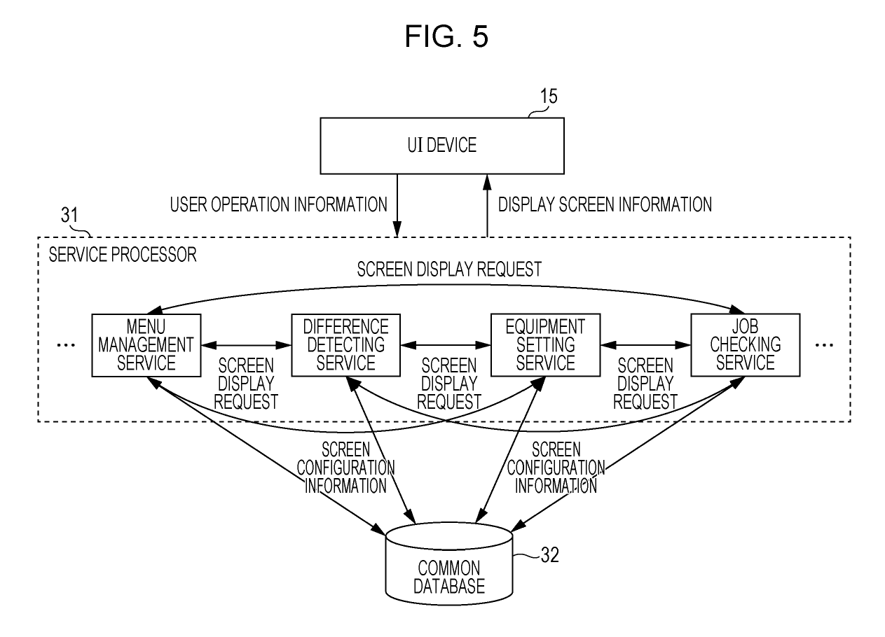

FIG. 5 is a block diagram illustrating the functional configuration of the image forming apparatus 10 which is implemented by executing the above-described control programs.

As illustrated in FIG. 5, the image forming apparatus 10 according to the exemplary embodiment has a configuration in which a service processor 31 runs various service applications, such as a menu management service, the difference detecting service, the equipment setting service, and a job checking service.

A difference detecting application for performing the difference detecting service is an application for performing a specific function. An equipment setting application for performing the equipment setting service and a job checking application for performing the job checking service are applications for performing common functions which are commonly used from multiple applications for specific functions.

Each application in the service processor 31 causes a process to be performed by using data stored in a common database 32, causes display screen information to be transmitted to the UI device 15 so as to display a screen, and causes operation information to be received from a user.

In the exemplary embodiment, not only is a screen display request transmitted from the menu management service to the difference detecting service or the like, but also a screen display request may be directly transmitted among the difference detecting service, the equipment setting service, and the job checking service, not via the menu screen.

When each of various services, such as the menu management service, the difference detecting service, the equipment setting service, and the job checking service, receives an instruction to make a transition to an operation screen of a different service, the service obtains screen configuration information from the common database 32, and transmits, to the different service application indicated in the instruction, a screen display request as well as specifying information for specifying the operation screen that is to be displayed on the basis of the obtained screen configuration information.

The service processor 31 causes the UI device 15 to display an operation screen of each of various services. At that time, on an operation screen for a specific function such as the difference detecting service, the service processor 31 displays a tab (operation receiving section) for making a direct transition to an operation screen for performing a common function related to the specific function. On the operation screen for the common function to which a transition has been made through an operation on the tab, the service processor 31 also displays a tab for returning back to the operation screen for the specific function.

A direct transition to an operation screen of a different service means that a transition is made not via a different operation screen such as a menu screen.

That is, the image forming apparatus 10 according to the exemplary embodiment has a configuration in which a transition between an operation screen for a specific function and an operation screen for a common function related to the process for the specific function may be made, not via a different operation screen such as a menu screen, on the basis of an operation of switching between tabs.

A case in which the difference detecting service is used as a specific function service and in which common functions related to the difference detecting service are the equipment setting service and the job checking service will be described below.

The equipment setting service is an exemplary setting function for setting various setting information necessary to perform the difference detecting service. The job checking service is an exemplary checking function for checking execution results of the difference detecting service.

In the image forming apparatus 10 according to the exemplary embodiment, information displayed on an operation screen for a common function to which a transition has been made from the menu screen is different from information displayed on the operation screen for the common function to which a transition has been made from an operation screen for a specific function such as the difference detecting service.

Specifically, on an operation screen of the equipment setting service or the job checking service to which a transition has been made from an operation screen for a specific function such as the difference detecting service, a tab for making a direct transition to the operation screen or the like of the difference detecting service is displayed, while such a tab is not displayed on an operation screen for a common function to which a transition has been made from the menu screen.

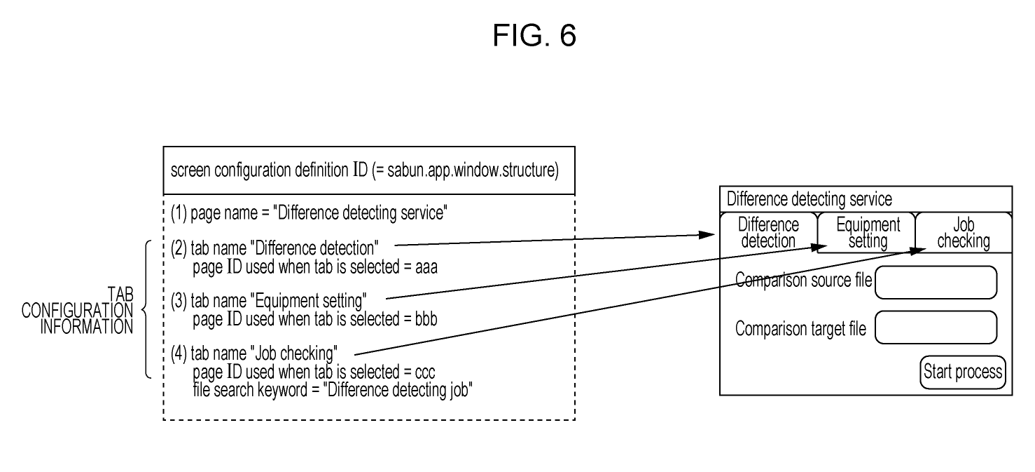

FIG. 6 illustrates exemplary screen display data for displaying an operation screen for the difference detecting application. The screen display data which is described by using the eXtensible Markup Language (XML) is stored in the common database 32.

In the data for displaying a difference detecting application screen, a screen configuration definition ID (identifier) is set to “sabun.app.wiondow.structure”. In transmission of a screen display request, the screen configuration definition ID is included in the screen display request so that it is possible to grasp the display configuration of the operation screen.

In the data for displaying a difference detecting application screen, information “Difference detecting service” is set as a page name, and name information of a tab that is to be displayed, a page ID for specifying a page that is to be displayed when the tab is selected, and the like are set as tab configuration information.

In the exemplary embodiment, tab configuration information for displaying tabs of “Difference detection”, “Equipment setting”, and “Job checking” is set. For the tab configuration information for which tab name is “Job checking”, information “Difference detecting job” is set as a file search keyword, which indicates an instruction that, in display of an operation screen for checking jobs, a keyword of “Difference detecting job” is to be used to search files so that the search result is displayed.

Thus, data for defining the screen configuration of an operation screen for a specific function and operation screens for common functions includes pieces of information for displaying a tab and the page ID (identifier) of a screen displayed when the tab is operated. The data for defining the screen configuration of an operation screen for a specific function and operation screens for common functions also includes specifying information for specifying display information used in display of an operation screen for a common function.

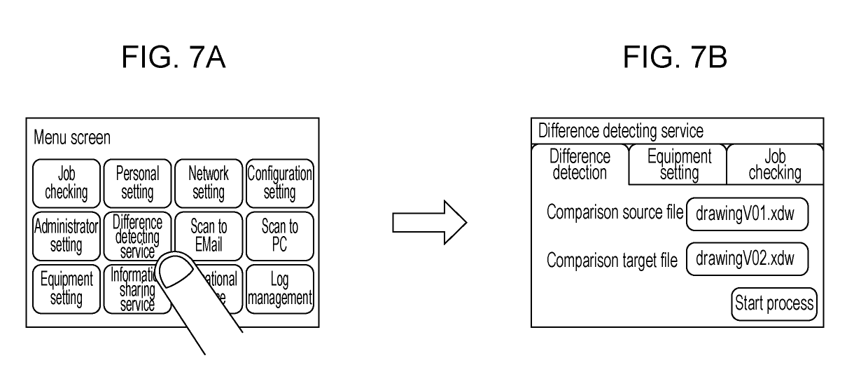

When a “Difference detecting service” button is operated on a menu screen as illustrated in FIG. 7A, the data for displaying a difference detecting application screen is used to display an operation screen of the difference detecting service as illustrated in FIG. 7B.

On the operation screen of the difference detecting service illustrated in FIG. 7B, selection of a tab of “Equipment setting” causes an operation screen of the equipment setting service to be displayed, and selection of a tab of “Job checking” causes an operation screen of the job checking service to be displayed.

Similarly, the display may be returned back from the operation screen of the equipment setting service or the operation screen of the job checking service to the operation screen of the difference detecting service, not via the menu screen.

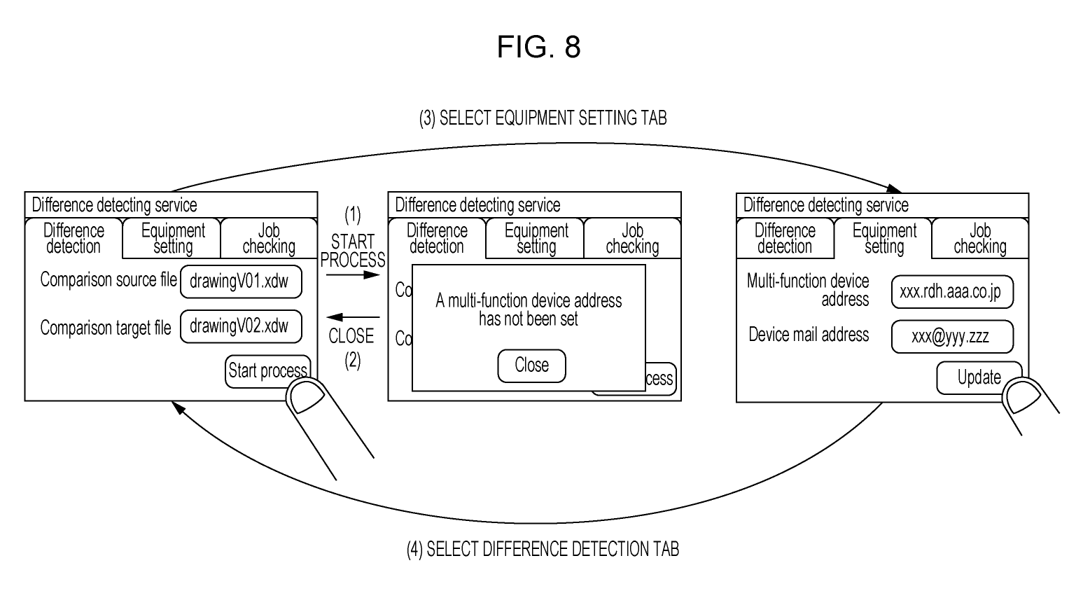

FIG. 8 illustrates an operational procedure used when operations for which the operational context is the same as that in FIG. 3 are performed in the image forming apparatus 10 according to the exemplary embodiment.

The operational procedure according to the exemplary embodiment which is illustrated in FIG. 8 will be described below.

(1) A user specifies a comparison source file and a comparison target file on the operation screen, and operates the process start button.

(2) Since a multi-function device address and the like have not been set, a warning, “A multi-function device address has not been set”, is displayed. The user operates the “Close” button, and goes back to the original operation screen of the difference detecting service.

(3) Then, the user selects the “Equipment setting” tab on the difference detecting service screen, and makes a transition to the operation screen of the equipment setting service.

(4) Then, the user inputs a multi-function device address and the like on the operation screen of the equipment setting service, and presses the “Update” button to register the information. Then, the user selects the “Difference detection” tab, and goes back to the operation screen of the difference detecting service.

Thus, in the case where the operational context as illustrated in FIG. 3 is to be accomplished, the image forming apparatus 10 according to the exemplary embodiment achieves a similar operational context with a smaller number of operations as illustrated in FIG. 8.

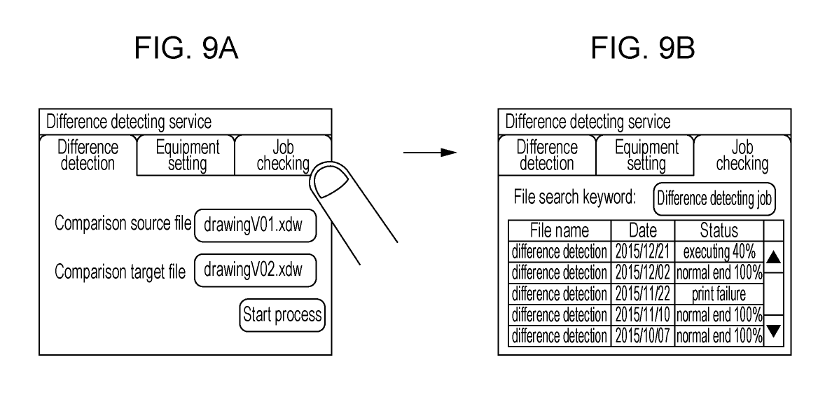

Screen display performed when the “Job checking” tab is selected on the operation screen of the difference detecting service will be described with reference to FIGS. 9A and 9B.

As illustrated in FIG. 9A, when the “Job checking” tab is selected on the operation screen of the difference detecting service, only the processing result for a search using a keyword of “Difference detecting job” is displayed among processing results for various jobs on the operation screen of the job checking service, as illustrated in FIG. 9B.

Thus, the reason why only the processing result of a search using a keyword of “Difference detecting job” is displayed on the operation screen of the job checking service is that, in the data for displaying a difference detecting application screen as illustrated in FIG. 6, a setting has been made so that a result obtained by performing a search with the file search keyword “Difference detecting job” is to be displayed on the operation screen displayed when the “Job checking” tab is selected.

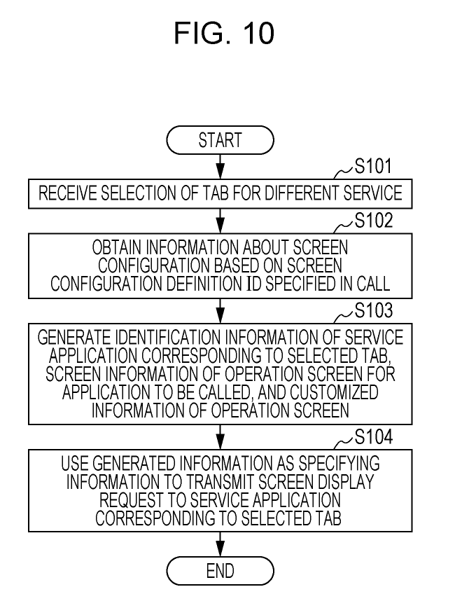

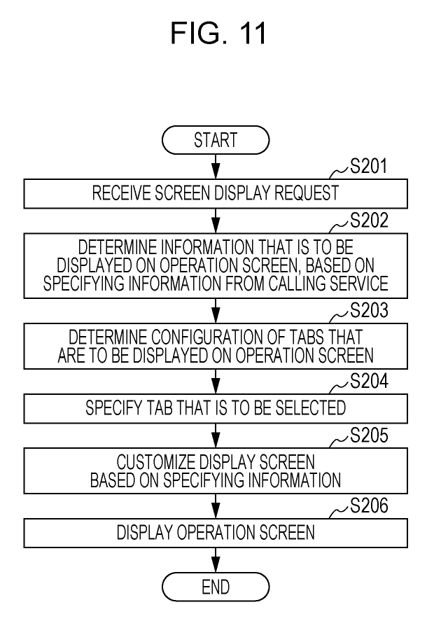

The detail of a process of switching between operation screens in the image forming apparatus 10 according to the exemplary embodiment will be described with reference to the flowcharts in FIGS. 10 and 11.

FIG. 10 is a flowchart for describing a process of switching between operation screens when a tab for a different service is selected.

For example, when the “Equipment setting” tab is selected on the operation screen for the difference detecting application (step S101), the difference detecting application obtains information about the screen configuration from the screen display data as illustrated in FIG. 6 which is stored in the common database 32, on the basis of the screen configuration definition ID (sabun.app.wiondow.structure) specified in a call from the menu screen (step S102).

The difference detecting application then generates identification information of the application corresponding to the selected tab, an operation screen for the application to be called, a tab configuration, customized information of the operation screen, and the like on the basis of information about the obtained screen configuration (step S103).

The difference detecting application uses the generated information as the specifying information, and transmits a screen display request to the equipment setting application corresponding to the selected tab (step S104).

FIG. 11 is a flowchart for describing a process performed when a screen display request is received from a different service.

When a service application receives a screen display request transmitted through the processes as illustrated in FIG. 10 (step S201), the service application determines information that is to be displayed on the operation screen, and the configuration of tabs that are to be displayed on the operation screen, on the basis of the specifying information received from the calling service (steps S202 and S203).

For example, when the equipment setting application receives a screen display request from the difference detecting application, the specifying information includes a message that a screen for inputting a multi-function device address which is an item of setting information necessary to execute the difference detecting application is to be displayed. The equipment setting application displays an operation screen for inputting a multi-function device address, on the basis of the specifying information.

The service application specifies a tab that is to be selected (step S204), and customizes the operation screen that is to be displayed, on the basis of the specifying information (step S205).

The service application which receives the screen display request displays the operation screen on which the information specified by using the specifying information is displayed (step S206). At that time, as a matter of course, the service application which displays the operation screen displays the tab for making a transition to the operation screen for the service application, in such a manner that the tab is being selected. Specifically, on the operation screen displayed by the equipment setting application, the tab for making a transition to the operation screen for the equipment setting application is displayed in such a manner as to be being selected.

In the exemplary embodiment, after a transition is made from the operation screen for the difference detecting application to the operation screen for the equipment setting application, a transition may be made to the operation screen for the job checking application. After a transition is made from the operation screen for the difference detecting application to the operation screen for the job checking application, a transition may be made to the operation screen for the equipment setting application. When switching is thus made between operation screens for common function applications without returning back to the operation screen for the difference detecting application which is an application for a specific function, information indicating this may be notified to the difference detecting application which is an application for a specific function.

Such a process enables the difference detecting application to grasp that setting of equipment information necessary to perform the difference detecting process is normally completed, for example, after the difference detecting application transmits a screen display request to the equipment setting application, even when the difference detecting application receives a screen display request back from the job checking application.

In the exemplary embodiment, the case in which a service application which a user is going to execute is the difference detecting application is described. When an operation screen for another service application is displayed, common applications related to the service application are different. Therefore, the common applications corresponding to the service application are displayed as tabs on the operation screen.

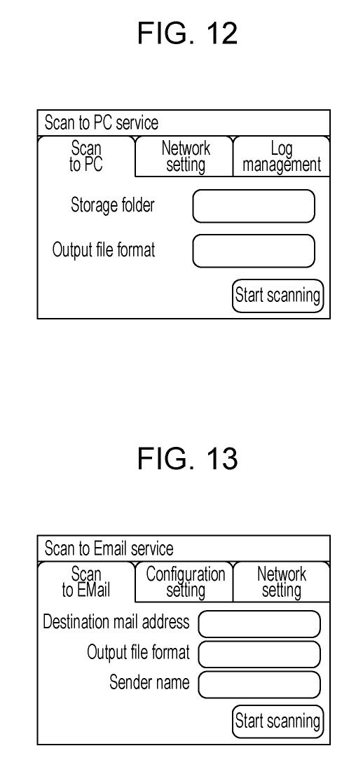

For example, as illustrated in FIG. 12, when a service application which a user is going to execute is a “Scan to PC” application, common applications of “Network setting” and “Log management” are displayed as tabs.

As illustrated in FIG. 13, when a service application which a user is going to execute is a “Scan to EMail” application, common applications of “Environment information” and “Network setting” are displayed as tabs.

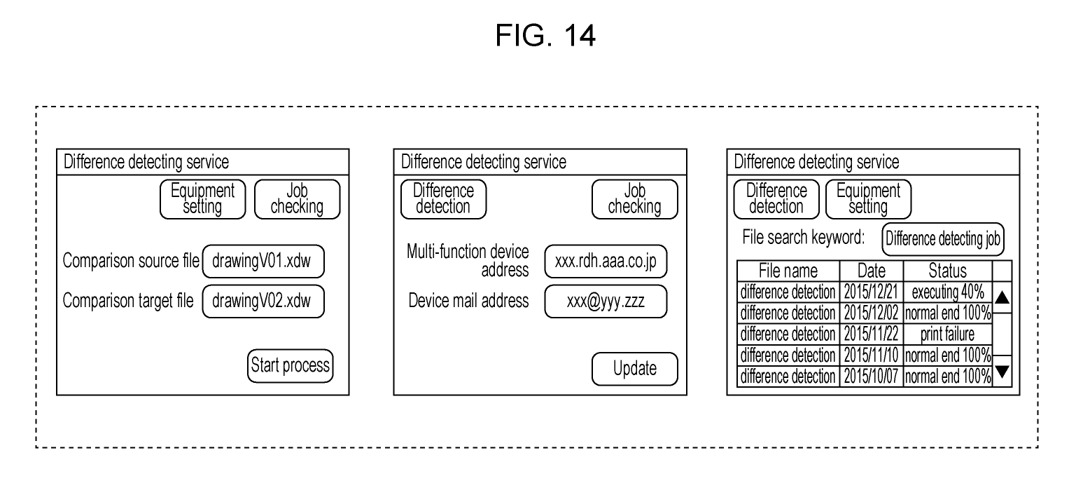

In the exemplary embodiment, the case in which the display is switched among the difference detecting service, the equipment setting service, and the job checking service through selection of a tab is described. The present invention is not limited to this configuration. As long as an operation receiving section is capable of receiving an operation from a user, an operation receiving section such as a simple link, not a tab, may achieve a similar process. For example, as illustrated in FIG. 14, operation buttons for making a transition among the difference detecting service, the equipment setting service, and the job checking service may be displayed. An operation on an operation button may cause a transition to be made to an operation screen of a different service.

### MODIFIED EXEMPLARY EMBODIMENTS

In the above-described exemplary embodiment, the case in which the present invention is applied to an image forming apparatus is described. The present invention is not limited to this. The present invention may be applied in a similar manner to any information processing apparatus in which service applications for providing specific functions and common applications which are commonly used from multiple service applications are executed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first execution unit that performs a specific function;
a second execution unit that performs a common function which is commonly used from a plurality of specific functions; and
a display that displays, on an operation screen for a specific function, an operation receiving section for making a direct transition to an operation screen for performing a common function related to the specific function, not via another operation screen, and that displays, on the operation screen for the common function to which a transition has been made through an operation on the operation receiving section, an operation receiving section for returning back to the operation screen for the specific function.

2. The information processing apparatus according to claim 1,
wherein the common function related to the specific function is a setting function for performing setting of setting information used to perform the specific function, or a checking function for checking an execution result for the specific function.

3. The information processing apparatus according to claim 1,
wherein information displayed on an operation screen which is a screen for the common function and to which a transition has been made from a function list screen is different from information displayed on an operation screen which is a screen for the common function and to which a transition has been made from an operation screen for the specific function.

4. The information processing apparatus according to claim 2,
wherein information displayed on an operation screen which is a screen for the common function and to which a transition has been made from a function list screen is different from information displayed on an operation screen which is a screen for the common function and to which a transition has been made from an operation screen for the specific function.

5. The information processing apparatus according to claim 1,
wherein data for defining a screen configuration of the operation screen for the specific function and the operation screen for the common function includes information for displaying an operation receiving section, and also includes an identifier of a screen that is to be displayed when the operation receiving section is operated.

6. The information processing apparatus according to claim 2,
wherein data for defining a screen configuration of the operation screen for the specific function and the operation screen for the common function includes information for displaying an operation receiving section, and also includes an identifier of a screen that is to be displayed when the operation receiving section is operated.

7. The information processing apparatus according to claim 5,
wherein the data for defining the screen configuration of the operation screen for the specific function and the operation screen for the common function includes specifying information for specifying information to be displayed when the operation screen for the common function is displayed.

8. The information processing apparatus according to claim 6,
wherein the data for defining the screen configuration of the operation screen for the specific function and the operation screen for the common function includes specifying information for specifying information to be displayed when the operation screen for the common function is displayed.

9. The information processing apparatus according to claim 1,
wherein the operation receiving section is a tab-shaped operation receiving section, and
wherein the display switches, for display, between the operation screen for the specific function and the operation screen for the common function on a basis of an operation on the tab-shaped operation receiving section.

10. The information processing apparatus according to claim 2,
wherein the operation receiving section is a tab-shaped operation receiving section, and
wherein the display switches, for display, between the operation screen for the specific function and the operation screen for the common function on a basis of an operation on the tab-shaped operation receiving section.

11. The information processing apparatus according to claim 3,
wherein the operation receiving section is a tab-shaped operation receiving section, and
wherein the display switches, for display, between the operation screen for the specific function and the operation screen for the common function on a basis of an operation on the tab-shaped operation receiving section.

12. The information processing apparatus according to claim 4,
wherein the operation receiving section is a tab-shaped operation receiving section, and
wherein the display switches, for display, between the operation screen for the specific function and the operation screen for the common function on a basis of an operation on the tab-shaped operation receiving section.

13. The information processing apparatus according to claim 5,
wherein the operation receiving section is a tab-shaped operation receiving section, and
wherein the display switches, for display, between the operation screen for the specific function and the operation screen for the common function on a basis of an operation on the tab-shaped operation receiving section.

14. The information processing apparatus according to claim 6,
wherein the operation receiving section is a tab-shaped operation receiving section, and
wherein the display switches, for display, between the operation screen for the specific function and the operation screen for the common function on a basis of an operation on the tab-shaped operation receiving section.

15. The information processing apparatus according to claim 7,
wherein the operation receiving section is a tab-shaped operation receiving section, and
wherein the display switches, for display, between the operation screen for the specific function and the operation screen for the common function on a basis of an operation on the tab-shaped operation receiving section.

16. The information processing apparatus according to claim 8,
wherein the operation receiving section is a tab-shaped operation receiving section, and
wherein the display switches, for display, between the operation screen for the specific function and the operation screen for the common function on a basis of an operation on the tab-shaped operation receiving section.

17. A non-transitory computer readable medium storing a program causing a computer to execute a process comprising:
displaying, on an operation screen for a specific function, an operation receiving section for making a direct transition to an operation screen for performing a common function related to the specific function, not via another operation screen, the common function being among common functions that are commonly used from a plurality of specific functions; and
on the operation screen for the common function to which a transition has been made through an operation on the operation receiving section, displaying an operation receiving section for returning back to the operation screen for the specific function.

18. An information processing method comprising:
displaying, on an operation screen for a specific function, an operation receiving section for making a direct transition to an operation screen for performing a common function related to the specific function, not via another operation screen, the common function being among common functions that are commonly used from a plurality of specific functions; and
on the operation screen for the common function to which a transition has been made through an operation on the operation receiving section, displaying an operation receiving section for returning back to the operation screen for the specific function.
